(19) United States
(12) Patent Application Publication
(10) Pub. No.: US 2010/0027563 A1
(43) Pub. Date: Feb. 4, 2010

(54) EVOLUTION CODES (OPPORTUNISTIC ERASURE CODING) PLATFORM

(75) Inventors: Jitendra D. Padhye, Redmond, WA (US); Ratul Mahajan, Seattle, WA (US); Sharad Agarwal, Seattle, WA (US); Brian Don Zill, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/261,465

(22) Filed: Oct. 30, 2008

Related U.S. Application Data
(63) Continuation-in-part of application No. 12/183,848, filed on Jul. 31, 2008.

(51) Int. Cl. H04J 3/24

(52) U.S. Cl. 370/474

(57) ABSTRACT

Systems and methods are provided that allow for the opportunistic erasure coding of data packets by employing an exemplary evolution code. In an illustrative implementation an exemplary computing environment comprises an evolution code engine and an instruction set comprising at least one instruction to instruct the evolution code to process data for communication between two or more components of the exemplary computing environment. The use of evolution coding mitigates packet losses along one or more communication paths. In an illustrative operation, coded packets are created by XOR-ing data packets together such that a coded packet can recover a lost data packet using other received packets.

### CROSS-REFERENCE TO RELATED APPLICATIONS

This application is a continuation-in-part (CIP) application of U.S. patent application Ser. No. 12/183,848 filed on Jul. 31, 2008, entitled, “INVERSE MULTIPLEXING HETEROGENEOUS WIRELESS LINKS FOR HIGH PERFORMANCE VEHICULAR CONNECTIVITY,” the entirety of this application is herein incorporated by reference.

### BACKGROUND

The erasure coding of communication packets promotes efficiency when such packets are communicated between cooperating components of a communications environment and/or a computing environment. A number of erasure coding techniques have been developed and deployed that allow for the transmission and processing of data packets that improve efficiency and reliability in lossy environments. Erasure coding techniques leverage various data processing methodologies to allow for the reconstruction of lost data packets.

However, all existing erasure coding techniques, such as Reed-Solomon or LT codes, focus on full recovery of all data. Such techniques operate to encode “K” data packets into more than “K” coded packets. As long as the receiver receives a threshold number of the total (data+coded) packets, it can recover all K” packets. However, when fewer than this threshold number is received, very few data packets may be recovered.

In highly dynamic environments, it is hard to guarantee that there is enough capacity to even send a threshold number of data packets, let alone a threshold number being received. It is thus appreciated that there exists a need for erasure coding methodologies that aim for partial recovery of data based on whatever resources are available.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject matter described herein provides for systems and methods that allow for the opportunistic coding of data packets by employing an exemplary evolution code. In an illustrative implementation an exemplary computing environment comprises an evolution code engine and an instruction set comprising at least one instruction to instruct the evolution code to process data for communication between two or more components of the exemplary computing environment.

In an illustrative operation, coded packets are created by XOR-ing data packets together. For simplicity, coded packets that could not be immediately decoded at the receiver of the exemplary computing environment are illustratively discarded. In the illustrative operation, a coded packet can recover one data packet. In the illustrative operation, the complexity of the coded packets (i.e., the number of included data packets), evolves with link conditions, window of data packets, and past history of coded packets. It increases as more coded packets are generated and decreases when new data is included in the window.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a flow diagram of an exemplary method for communicating data across one or more communications links in accordance with the herein described systems and methods.

FIG. 1A is a flow diagram of an exemplary method for communicating data using complimentary processing threads in accordance with the herein described systems and methods.

FIG. 1B is a flow diagram of an exemplary method for communicating data using other complimentary processing threads in accordance with the herein described systems and methods.

FIG. 2 is a flow diagram of an exemplary method for communicating data deploying opportunistic erasure coding and minimum path delay in accordance with the herein described systems and methods.

FIG. 3 is a block diagram of an exemplary computing environment.

FIG. 4 is a block diagram of an exemplary networked computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Evolution Codes Overview:

The herein described systems and methods comprise an exemplary evolution code engine operative such that coded packets can be sent when there are instantaneous openings in an exemplary communications path's spare capacity. Packets can be coded using exemplary Evolution codes that we have developed to maximize the expected number of packets recovered with each coded packet. In the illustrative implementation, a second technique can operatively allow the evolution code engine to transmit data packets along the communications link that is identified to maintain the minimum delay path (i.e., relative to other communications links).

In the illustrative implementation, the Evolution code engine is operative to deploy an opportunistic erasure coding technique that illustratively masks losses from applications. Instantaneous openings in the communications path's available bandwidth can be exploited to send erasure coded packets. The openings can be judged using an estimate of queue length and capacity at the bottleneck communications link. In the illustrative implementation, coded packets do not steal bandwidth from future data packets.

Illustratively, packets can be coded using exemplary Evolution codes that operate to maximize the expected number of packets recovered with each coded packet. Opportunistic erasure coding can provide efficiencies over retransmitting lost packets based on feedback from the other proxy because path delays tend to be high. Additionally, it can can also provide efficiencies over existing erasure coding methods such as Reed-Solomon or LT codes, because it can better leverage any spare capacity along communication paths.

In an illustrative implementation, an Evolution code can be considered an erasure coding method/process operative to determine the contents of each coded packet transmitted by the exemplary Evolution code engine. In an illustrative operation, since, a priori, it is not determined how many additional coded packets can be sent across an exemplary communications path, each coded packet can maximize the expected number of packets that will be recovered. Stated differently, partial recovery rather than optimizing the number of packets needed for full recovery is performed.

For example, with an exemplary Evolution code, at any given instant, the sender can operatively code over a set of data packets W (e.g., those that were sent within the previous round trip time). In the exemplary, the sender also can operatively estimate the fraction r of the W packets (but not necessarily which exact packets) that has been successfully recovered by the receiver, based on past transmissions of data and coded packets. For tractability, each packet in W can maintain the same probability, equal to r, of being present at the receiver. In practice, the probabilities of different packets may differ based on the contents of earlier packets and the paths over which they were sent. In an illustrative operation, coded packets by XOR-ing data packets together can be created. Given, in the example, that all packets have the same probability of being there at the receiver, a selected number packets can be XOR'd. The selected number can be based on an operational property that coded packets that could not be immediately decoded at the receiver are discarded, and thus a coded packet can recover at most one data packet.

For example, suppose the sender XORs x (1≦x≦|W|) data packets in W. The probability that this coded packet will yield a previously missing data packet at the receiver is equal to the probability that exactly one out of the x packets is lost. That is, the expected yield Y (x) of this packet is:

Y(x)=x×(1−r)×r^{x 1}

Y (x) is maximized for

$$x = \frac{- 1}{ln ( r )} \vert$$

If the expected number of data packets at the receiver (i.e., r x |W|) is low, the coded packet should contain few data packets. For instance, if more than half of the packet are missing, only one packet at a time (i.e. essentially re-send one of the packets in W) can be sent; coding even two does not result in an efficiency since the probability of both packets being absent, and hence of nothing being recovered, is high. Conversely, if more packets are already there at the receiver, encoding more packets can recover missing data more efficiently.

Thus, in Evolution code engine, the sender selects

$$max ( 1 , ⌊ \frac{- 1}{ln ( r )} ⌋ ) \vert$$

data packets at random to XOR. Illustratively, the number of packets is round down because including fewer data packets provides betterresults. Furthermore, if |W|>1 and └−1/ln (r)┘≧|W|, XOR only |W|−1 packets. The entire window of packets is not XOR'd because of a subtle corner case that arises if the window of packets is not changing and more than one data packet is missing at the receiver but the sender estimates that fewer data packets are missing. In this case, the direct application of the Evolution code could result in the repeated transmission of the same deterministic coded packet at each opportunity. This packet, however, would be unable to recover any more packet s at the receiver.

In the illustrative implementation, W and r can be updated according to the following illustrative process. The sender updates the set of packets W and estimated fraction r as follows.

i) When a new data packet is sent, it is first added to W, and then:

$$r = \frac{( \vert W \vert - 1 ) \times r + ( 1 - p )}{\vert W \vert}$$

where p is an estimate of the loss rate of the path along which the packet is sent. Receivers can operatively estimate p using an exponential averaging of past behavior and periodically inform the sender of the current estimate.

ii) When a coded packet, formed by XOR'ing x data packets, is sent, W does not change, and

$$r = \frac{\vert W \vert \times r + ( 1 - p ) \times Y ( x )}{\vert W \vert}$$

where Y (x) is defined above.

iii) When feedback from the receiver is received, which indicates which packets have been received—this information can be embedded in packets flowing in the other direction—some packets can be removed from W, and r is unchanged.

In the illustrative implementation, we can also stripe data across one or more communications paths offered by the various communications links based on an estimated delivery delay along the one or more communications paths. In the illustrative implementation, delivery delay can be estimated by estimating communication path capacity, bottleneck link's queue length, and communication path's propagation delay. The striping decision for each packet can be taken independently. In the illustrative implementation, the faster communication path will be selected until the queues on this path increase the delay to increase its delay to that of the slower path.

### Deployment of Evolution Codes:

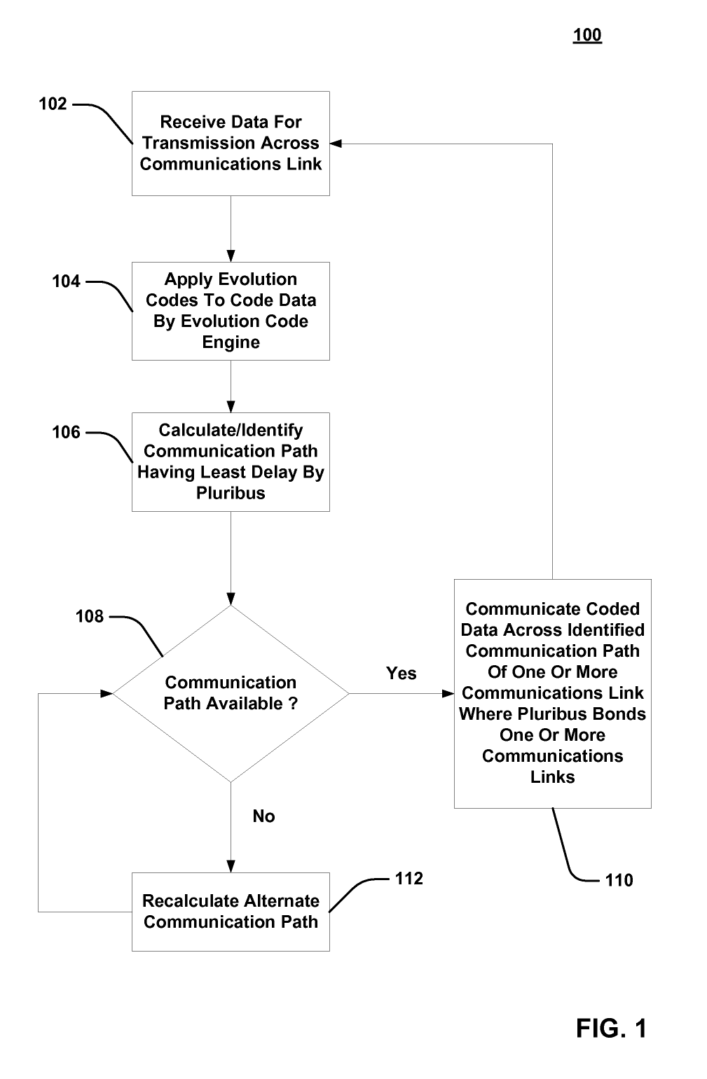

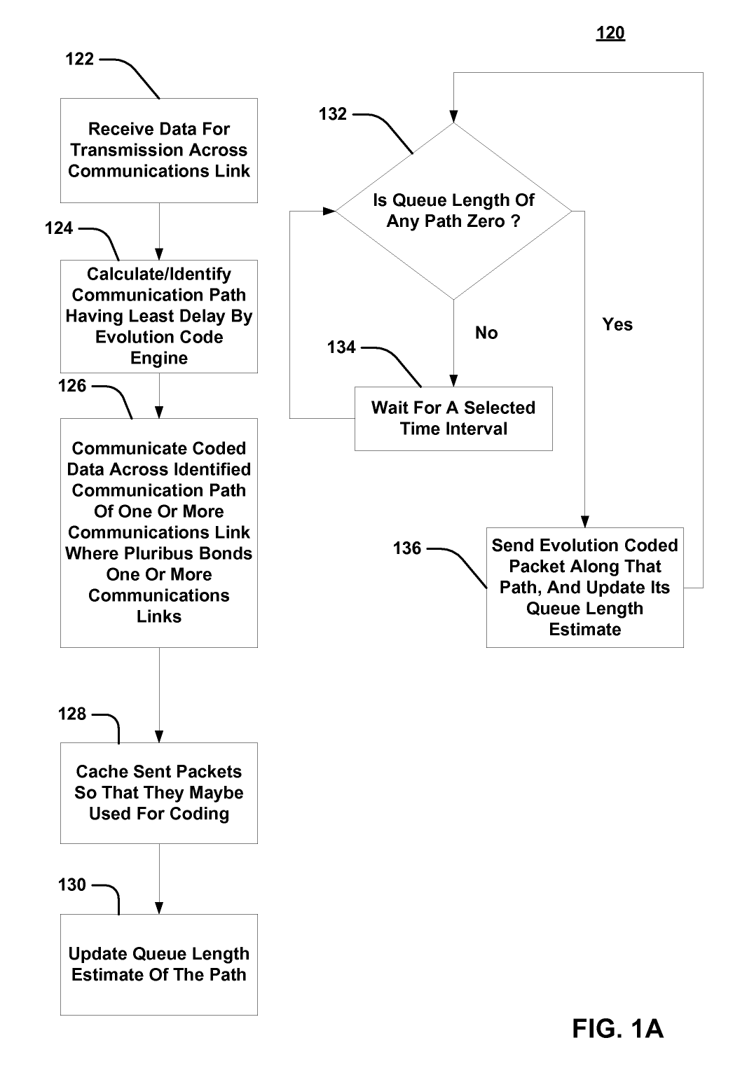

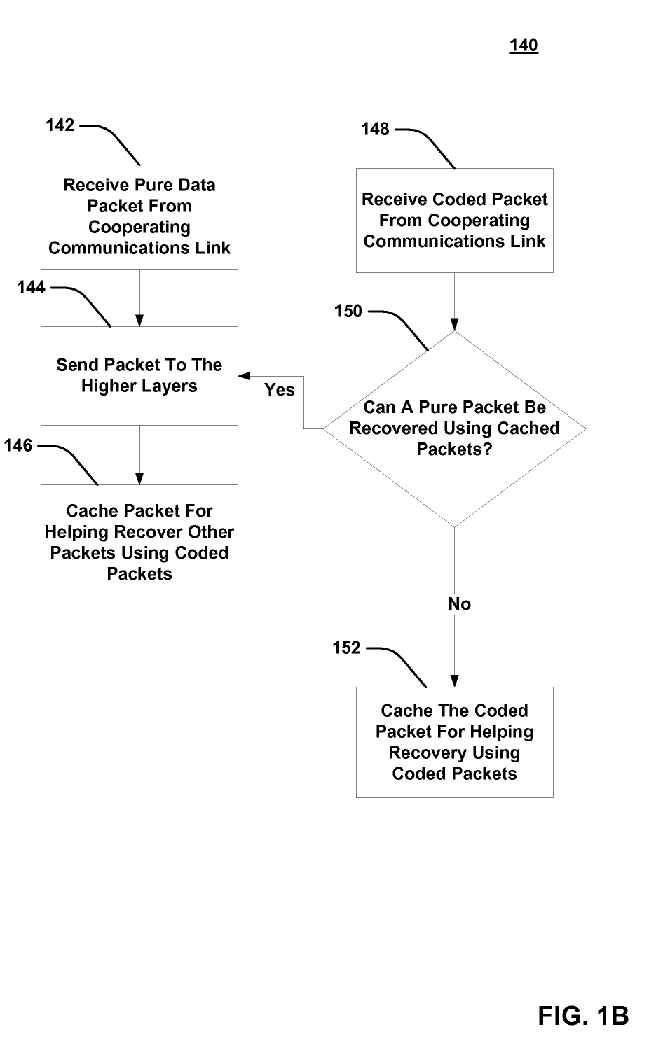

FIG. 1 is a flow diagram of one example of a method 100 performed to mitigate loss across a communications environment. As is shown, processing begins at block 102 where data is received for transmission across one or more communications links. Processing then proceeds to block 104 where one or more evolution codes are applied to the code received data by an exemplary evolution code engine. The communication path having the least delay is calculated/identified by the Evolution code engine at block 106. A check is then performed at block 108 to determine if the identified communication path is available.

If the check at block 108 indicates that the identified communication path is available, processing proceeds to block 110 where the coded data (e.g., coded according to the one or more evolution codes) is communicated across the identified communication path of the one or more cooperating communications links at block 110. Processing then reverts to block 102 and proceeds from there. However, if the check at block 108 indicates that the identified communication path is not available, processing proceeds to block 112 where an exemplary Evolution code engine recalculates an alternate communication path. Processing then proceeds back to block 108 and continues from there.

FIG. 1A is a flow diagram of one example of a method 120 performed to send data using complimentary processing threads. As is shown in an exemplary first processing thread, processing begins at block 122 where data is received for transmission across a communications link. Processing then proceeds to block 124 where a communication path is calculated/identified by an exemplary Evolution code engine having the least delay (i.e., among the available communications links). Processing then proceeds to block 126 where coded data is communicated across the identified communication path of the one or more communications paths where the Evolution code engine bonds one or more communications paths. Packets can then be sent to a cooperating cache for use in coding at block 128. The queue length estimate of the identified communications path is then updated at block 130.

Further, as is shown in FIG. 1A, a complimentary processing thread can be performed. As is shown, the second complimentary processing thread begins at block 132 where a check is performed to determine if the queue length of any path is zero. If the check at block 132 indicates that the queue length is zero, processing proceeds to block 136 where an evolution coded packet is sent along the identified communication path and the queue length estimate is also updated. Processing then reverts to block 132 and proceeds from there. However, if the processing at block 132 indicates that there isn't a queue length of any path equal to zero, processing proceeds to block 134 where the exemplary evolution code engine waits for a selected time interval. Processing then reverts to block 132 and proceeds from there.

FIG. 1B is a flow diagram of one example of a method 540 performed to receive data using complimentary processing threads. As is shown, processing on a first thread begins at block 142 where a pure (e.g., not coded) data packet is received from a cooperating communications path. Processing then proceeds to block 144 where the packet is sent to higher layers for processing. The packet is then cached at block 146 and can be used for helping recover other packets using decoding.

Further, as is shown, in FIG. 1B, a complimentary processing thread can be performed. As is shown in, processing begins at block 148 where a coded packet is received from a cooperating communications link. Processing then proceeds to block 150 where a check is performed to determine if a pure packet (e.g., not coded packet) can be recovered using the cached packets. If the check at block 150 indicates that a pure packet cannot be recovered, processing proceeds to block 152 where the coded packet is cached for use in assisting recovery operations using coded packets. However, if the check at block 150 indicates that a pure packet can be recovered using cached packets, processing jumps to block 544 and proceeds from there.

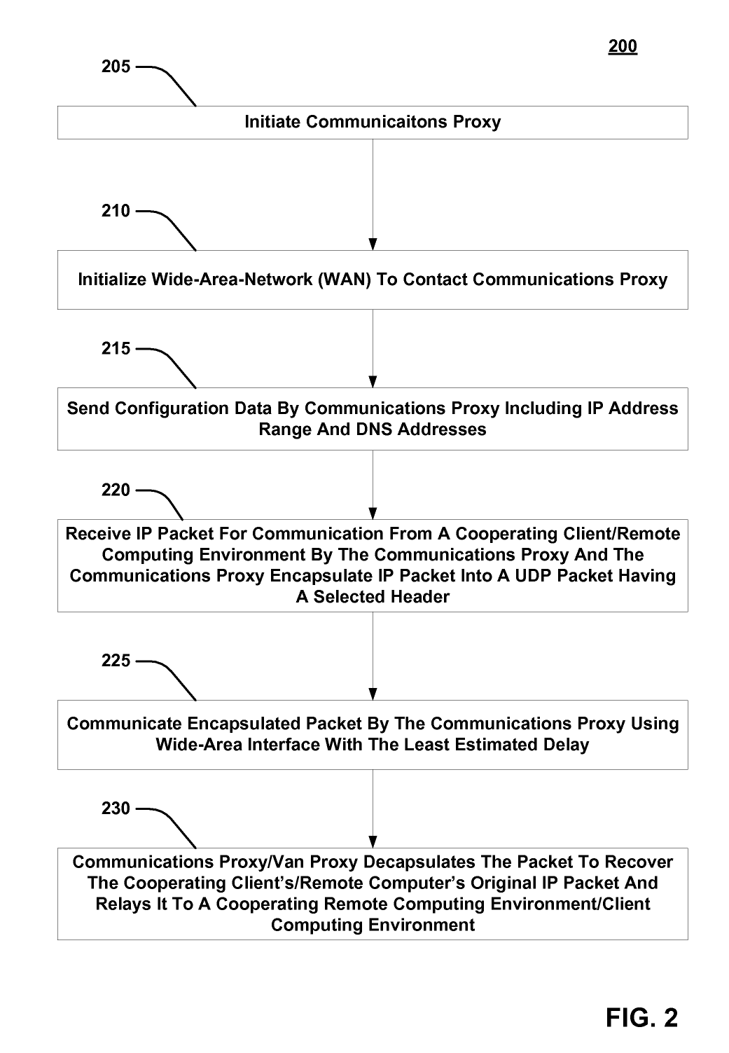

FIG. 2 is a flow diagram of one example of a method 200 performed to deploy and execute an exemplary evolution code engine as part of a communication environment. As is shown in FIG.2, processing begins at block 205 where an exemplary communications proxy is booted. Processing then proceeds to block 210 where a wide-area-network (WAN) is initialized to allow communication between an exemplary communications proxy. Confirmation data is then sent between the cooperating communications proxies including Internet packet (IP) address range and domain name server (DNS) addresses. IP packets intended for communication across the communications environment are then received from a cooperating client and/or remote computing environment by the communications proxy respectively for encapsulation by the communications proxy into a user datagram protocol (UDP) packet having a selected header. The encapsulated packet is then communicated by the communications proxy, respectively, using a wide-area interface having the least estimated delay. At block 230, the communications proxy decapsulates the received packet to recover the cooperating client's/remote computer's original IP packet and relays the original decapsulated IP packet to a cooperating remote computing environment/client computing environment, respectively.

It is appreciated that although exemplary method 200 is described to perform various acts between exemplary components of a communications proxy that such description is merely illustrative as the systems and methods described herein allow for the performance of various acts between various cooperating components of a communications environment not described by method 200.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

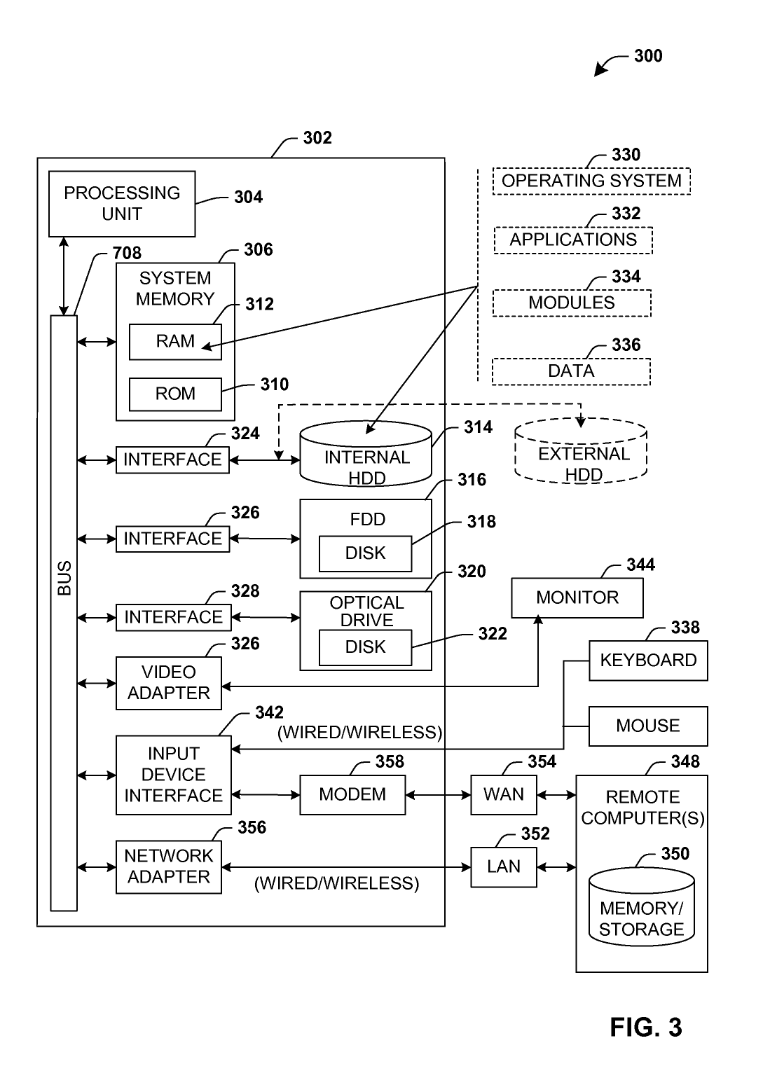

FIG. 3 illustrates a block diagram of a computer operable to execute the disclosed architecture. In order to provide additional context for various aspects of the subject specification, FIG. 3 and the following discussion are intended to provide a brief, general description of a suitable computing environment 300 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 3, an example environment 300 for implementing various aspects as described in the specification includes a computer 302, the computer 302 including a processing unit 304, a system memory 306 and a system bus 308. The system bus 308 couples system components including, but not limited to, the system memory 306 to the processing unit 304. The processing unit 304 can be any of various commercially available processors. Dual microprocessors and other multi-processor architectures may also be employed as the processing unit 304.

The system bus 308 can be any of several types of bus structure that may further interconnect to a memory bus (with or without a memory controller), a peripheral bus, and a local bus using any of a variety of commercially available bus architectures. The system memory 306 includes read-only memory (ROM) 310 and random access memory (RAM) 312. A basic input/output system (BIOS) is stored in a non-volatile memory 310 such as ROM, EPROM, EEPROM, which BIOS contains the basic routines that help to transfer information between elements within the computer 302, such as during start-up. The RAM 312 can also include a high-speed RAM such as static RAM for caching data.

The computer 302 further includes an internal hard disk drive (HDD) 314 (e.g., EIDE, SATA), which internal hard disk drive 314 may also be configured for external use in a suitable chassis (not shown), a magnetic floppy disk drive (FDD) 316, (e.g., to read from or write to a removable diskette 318) and an optical disk drive 320, (e.g., reading a CD-ROM disk 322 or, to read from or write to other high capacity optical media such as the DVD). The hard disk drive 314, magnetic disk drive 316 and optical disk drive 320 can be connected to the system bus 308 by a hard disk drive interface 324, a magnetic disk drive interface 326 and an optical drive interface 328, respectively. The interface 324 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 312, including an operating system 330, one or more application programs 332, other program modules 334 and program data 336. All or portions of the operating system, applications, modules, and/or data can also be cached in the RAM 312. It is appreciated that the specification can be implemented with various commercially available operating systems or combinations of operating systems.

A user can enter commands and information into the computer 302 through one or more wired/wireless input devices, e.g., a keyboard 338 and a pointing device, such as a mouse 340. Other input devices (not shown) may include a microphone, an IR remote control, a joystick, a game pad, a stylus pen, touch screen, or the like. These and other input devices are often connected to the processing unit 304 through an input device interface 342 that is coupled to the system bus 308, but can be connected by other interfaces, such as a parallel port, an IEEE 1394 serial port, a game port, a USB port, an IR interface, etc.

A monitor 344 or other type of display device is also connected to the system bus 308 via an interface, such as a video adapter 346. In addition to the monitor 344, a computer typically includes other peripheral output devices (not shown), such as speakers, printers, etc.

The computer 302 may operate in a networked environment using logical connections via wired and/or wireless communications to one or more remote computers, such as a remote computer(s) 348. The remote computer(s) 348 can be a workstation, a server computer, a router, a personal computer, portable computer, microprocessor-based entertainment appliance, a peer device or other common network node, and typically includes many or all of the elements described relative to the computer 302, although, for purposes of brevity, only a memory/storage device 350 is illustrated. The logical connections depicted include wired/wireless connectivity to a local area network (LAN) 352 and/or larger networks, e.g., a wide area network (WAN) 354. Such LAN and WAN networking environments are commonplace in offices and companies, and facilitate enterprise-wide computer networks, such as intranets, all of which may connect to a global communications network, e.g., the Internet.

When used in a LAN networking environment, the computer 302 is connected to the local network 352 through a wired and/or wireless communication network interface or adapter 356. The adapter 356 may facilitate wired or wireless communication to the LAN 352, which may also include a wireless access point disposed thereon for communicating with the wireless adapter 356.

When used in a WAN networking environment, the computer 302 can include a modem 358, or is connected to a communications server on the WAN 354, or has other means for establishing communications over the WAN 354, such as by way of the Internet. The modem 358, which can be internal or external and a wired or wireless device, is connected to the system bus 308 via the serial port interface 342. In a networked environment, program modules depicted relative to the computer 302, or portions thereof, can be stored in the remote memory/storage device 350. It will be appreciated that the network connections shown are example and other means of establishing a communications link between the computers can be used.

The computer 302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

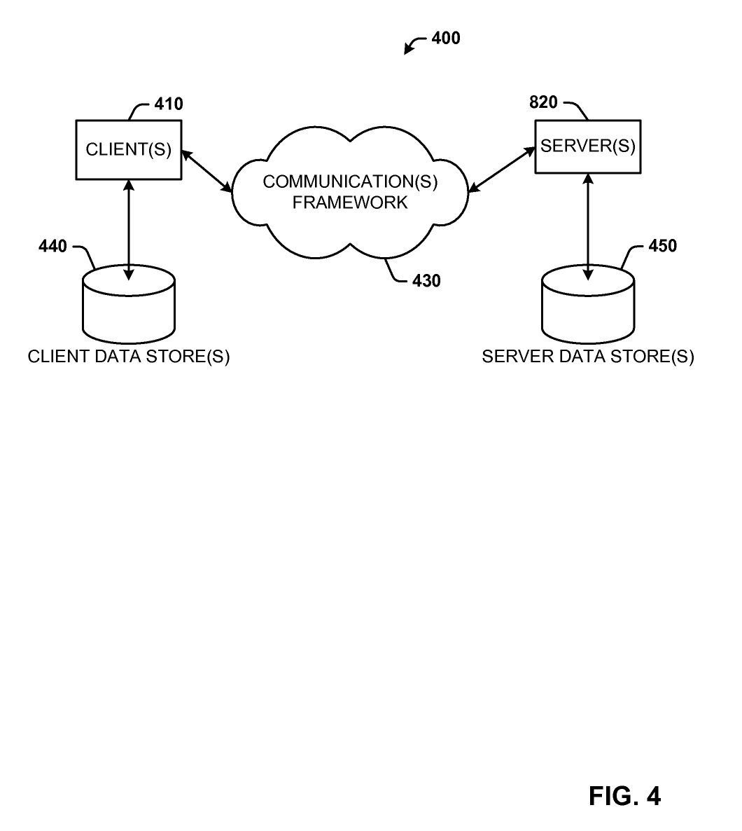

Referring now to FIG. 4, there is illustrated a schematic block diagram of an exemplary computing environment 400 in accordance with the subject invention. The system 400 includes one or more client(s) 410. The client(s) 410 can be hardware and/or software (e.g., threads, processes, computing devices). The client(s) 410 can house cookie(s) and/or associated contextual information by employing the subject invention, for example. The system 400 also includes one or more server(s) 420. The server(s) 420 can also be hardware and/or software (e.g., threads, processes, computing devices). The servers 420 can house threads to perform transformations by employing the subject methods and/or systems for example. One possible communication between a client 410 and a server 420 can be in the form of a data packet adapted to be transmitted between two or more computer processes. The data packet may include a cookie and/or associated contextual information, for example. The system 400 includes a communication framework 430 (e.g., a global communication network such as the Internet) that can be employed to facilitate communications between the client(s) 410 and the server(s) 420.

Communications can be facilitated via a wired (including optical fiber) and/or wireless technology. The client(s) 410 are operatively connected to one or more client data store(s) 440 that can be employed to store information local to the client(s) 410 (e.g., cookie(s) and/or associated contextual information). Similarly, the server(s) 420 are operatively connected to one or more server data store(s) 450 that can be employed to store information local to the servers 420.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system allowing for the communication of data across one or more lossy communications paths:
an evolution code engine operative to process data for communication across the one or more communications paths; and
an instruction set comprising at least one instruction instructing the evolution code engine to process data according to a selected communication path multiplexing paradigm,
wherein the selected communications link multiplexing paradigm comprises one or more properties including performing opportunistic erasure coding such that coded packets can be sent in the event that there are openings in the one or more communication links' capacity and transmitting data packets along the one or more communications links having been identified to provide one or more minimum delay paths.

2. The system as recited in claim 1, wherein the evolution code engine module is operative to estimate the queue length at a bottlenecked one of the one or more communications links of one or more communications paths on the one or more communications links.

3. The system as recited in claim 2, wherein the evolution code engine is operative to transmit one or more coded data packets across the one or more communications links when the estimated queue length is zero.

4. The system as recited in claim 1, wherein the wherein the evolution code engine module is operative to identify a communication path on the one or more communications links having the least amount of delay relative to the other one or more communications links.

5. The system as recited in claim 1, wherein the evolution code engine is operative to encode data for communication across the one or more communications links using one or more evolution codes.

6. The system as recited in claim 5, wherein the one or more evolution codes comprises one or more erasure code operations.

7. The system as recited in claim 6, wherein the one or more evolution codes comprise one or more operations comprising analyzing conditions of the communications link, processing a window of one or more data packets, analyzing past history of coded packets, and updating the evolution codes with data obtained when performing one or more of the evolution code operations.

8. The system as recited in claim 4, wherein the evolution code engine is operative to send newly arrived data packets along a communications path that has been identified as having the least amount of delay relative to the other one or more communications links.

9. The system as recited in claim 8, wherein the evolution code engine module is operative to process one or more properties of the one or more communications links when identifying the least taxed communication path.

10. The system as recited in claim 1, wherein the properties of the one or more communications links comprises the transmission time required to transmit one or more data packets across one or more communications paths of the one or more communications links, the time a data packet spends in a queue of the one or more communications links, and the propagation delay when communicating one or more data packets across the one or more communications links.

11. A method to facilitate data communications across one or more communications links comprising:
receiving data for communication across the one or more communications links;
encoding the data according to an opportunistic erasure coding paradigm;
identifying one or more communications paths for the one or more communications links having the least delay path relative to the other one or more communications links; and
communicating the encoded data packets across the identified one or more communications paths.

12. The method as recited in claim 11, further comprising utilizing one or more evolution codes when encoding the received data packets.

13. The method as recited in claim 12, further comprising deploying one or more selected erasure codes when communicating data across the communications links.

14. The method as recited in claim 12, further comprising utilizing one or more partial recovery techniques when utilizing the one or more evolution codes.

15. The method as recited in claim 11, further comprising processing transmission time for one or more communications paths of the one or more communications links when identifying the one or more communications paths having the least delay path.

16. The method as recited in claim 11, further comprising determining the time a data packet spends in a queue of the one or more communications links when identifying the one or more communications paths having the least delay path.

17. The method as recited in claim 11, further comprising determining the propagation delay for a data packet being communicated across the one or more communications links when identifying the one or more communications paths having the least delay path.

18. The method as recited in claim 17, further comprising providing two or more communications links proxies for use in communicating data across the one or more communications links.

19. The method as recited in claim 13, further comprising creating a bridge between the two or more communications proxies operative to tunnel packets over the one or more communications paths operative to connect the two or more communications proxies.

20. A computer-readable medium having computer executable instructions to instruct a computing environment to perform a method comprising:
receiving data for communication across the one or more communications links;
encoding the data according to an opportunistic erasure coding paradigm;
identifying one or more communications paths for the one or more communications links having the least delay path relative to the other one or more communications links; and
communicating the encoded data packets across the identified one or more communications paths.
